(19) United States
(12) Patent Application Publication
(10) Pub. No.: US 2012/0278176 A1
(43) Pub. Date: Nov. 1, 2012

(54) SYSTEMS AND METHODS UTILIZING FACIAL RECOGNITION AND SOCIAL NETWORK INFORMATION ASSOCIATED WITH POTENTIAL CUSTOMERS

(76) Inventors: Amir Naor, Ashkelon (IL); Gil Friedman, Bney-Atarot (IL)

(21) Appl. No.: 13/095,481

(22) Filed: Apr. 27, 2011

(51) Int. Cl. G06Q 30/00

(52) U.S. Cl. 705/14.66

(57) ABSTRACT

According to some embodiments, an online connection may be established with a remote potential customer. Image information, including the potential customer's face, may be captured and used to obtain a social network identifier associated with the potential customer. Social network information may then be collected, and an offer to be provided to the potential customer may be automatically identified based at least in part on the collected social network information. According to some embodiments, customer relationship management information may also be used to identify to offer.

### FIELD

Some embodiments relate to systems and methods associated with online interactions with potential customers. More specifically, some embodiments are directed to systems and methods utilizing facial recognition and social network information associated with potential customers.

### BACKGROUND

In some cases, a sales representative might wish to provide an offer to a potential customer. For example, the sales representative might offer to sell the potential customer a magazine subscription at a discounted price. Different potential customers, however, may be interested in different types of offers. For example, a twenty year old female might be more interested in purchasing yoga classes as compared to a seventy year old man. As a result, the selection of an appropriate offer for a potential customer can be important.

To facilitate selection of appropriate offers, Customer Relationship Management (“CRM”) systems and applications may be used to track prior interactions with the customer. For example, if it is known that a customer purchased a vacation package the previous spring it might be appropriate to offer the customer another vacation package one year later. It can be difficult, however, for a sales representative to associate a particular customer with the appropriate CRM information. Moreover, the CRM information may be incomplete and lack important information relevant to the selection of an offer for the potential customer.

Accordingly, a method and mechanism to efficiently, accurately, and automatically select appropriate offers for a potential customer may be provided in accordance with some embodiments described herein.

### BRIEF DESCRIPTION OF THE DRAWINGS

FIG. 1 is a block diagram of a system according to some embodiments.

FIG. 2 is a flow diagram of a process according to one embodiment that might be implemented.

FIG. 3 is more detailed diagram of a system in accordance with some embodiments

FIG. 4 is a flow diagram of a process according to some embodiments disclosed herein.

FIG. 5 illustrates a facial recognition display in accordance with some embodiments.

FIG. 6 illustrates a display that might be provided to a sales representative according to some embodiments.

FIG. 7 is a block diagram of a system according to some embodiments.

FIG. 8 is a portion of a tabular social network database in accordance with some embodiments.

FIG. 9 is a portion of a tabular CRM database in accordance with some embodiments.

FIG. 10 is a portion of a tabular offer database in accordance with some embodiments.

### DETAILED DESCRIPTION

In some cases, a sales representative might wish to provide an offer to a potential customer. Different potential customers, however, may be interested in different types of offers. As a result, the selection of an appropriate offer for a potential customer can be important. To facilitate selection of appropriate offers, CRM systems and applications may be used to track prior interactions with the customer. It can be difficult, however, for a sales representative to associate a particular customer with the appropriate CRM information, and the CRM information may lack important relevant to the selection of an offer for the potential customer.

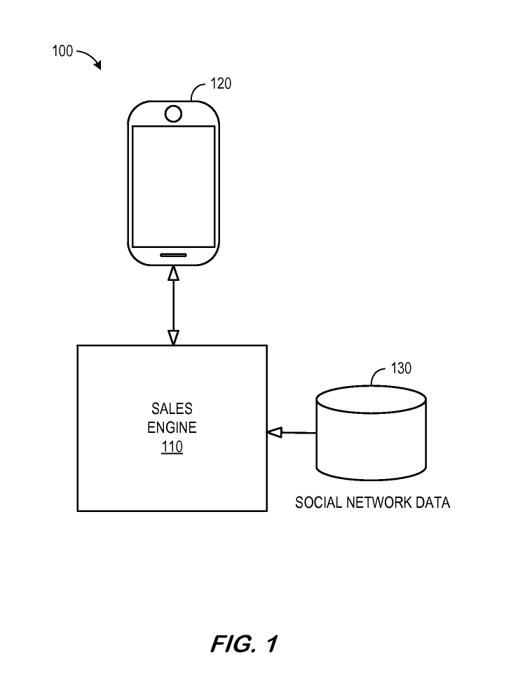

Accordingly, a method and mechanism to efficiently, accurately, and automatically select appropriate offers for a potential customer may be provided in accordance with some embodiments described herein. For example, FIG. 1 is a block diagram of a system 100 that might be associated with a sales representative. The system 100 includes a sales engine 110 that may establish a connection with a potential customer via a remote customer device 120. The sales engine 110 and/or remote customer device 120 may comprise, for example, Personal Computers (PCs), laptop computers, wireless smart phones, game systems, or another other appropriate device. According to some embodiments, the remote customer device 120 includes a camera adapted to capture an image (e.g., an image of the potential customer). According to other embodiments, the remote customer device 120 might instead communicates with a camera and/or store image information associated with the potential customer.

According to some embodiments, the sales engine 110 is further able to access “social network” data 130. A social network may include entities, such as potential customers, who may be “linked” to other entities who, in turn, may be linked to still other entities. Social network entities may be “linked,” for example, if they are friends or contacts on a social network web site. Such social networks are an increasing popular way for people to communicate and exchange information with friends (and friends of friends, etc.). For example, an entity might post or otherwise display information about his or her current activities or interests to be automatically distributed to other entities in the social network (e.g., in accordance with the pre-established links). For exemplary purposes, such sites/networks may include ebay.com, Facebook.com, LinkedIn.com, AngiesList.com, Twitter.com, Blogger.com, MySpace.com, Friendster.com, and other similar sites. The social network data 130 may be stored at a server or server farm remote from the sales engine 110.

Note that FIG. 1 represents a logical architecture according to some embodiments, and actual implementations may include more or different components arranged in other manners. Moreover, each system described herein may be implemented by any number of devices in communication via any number of other public and/or private networks. Two or more of devices may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

Any of the devices illustrated in FIG. 1, including the sales engine 110 and remote customer device 120, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

All systems and processes discussed herein may be embodied in program code stored on one or more computer-readable media. Such media may include, for example, a floppy disk, a CD-ROM, a DVD-ROM, magnetic tape, OR solid state Random Access Memory (RAM) or Read Only Memory (ROM) storage units. Embodiments are therefore not limited to any specific combination of hardware and software.

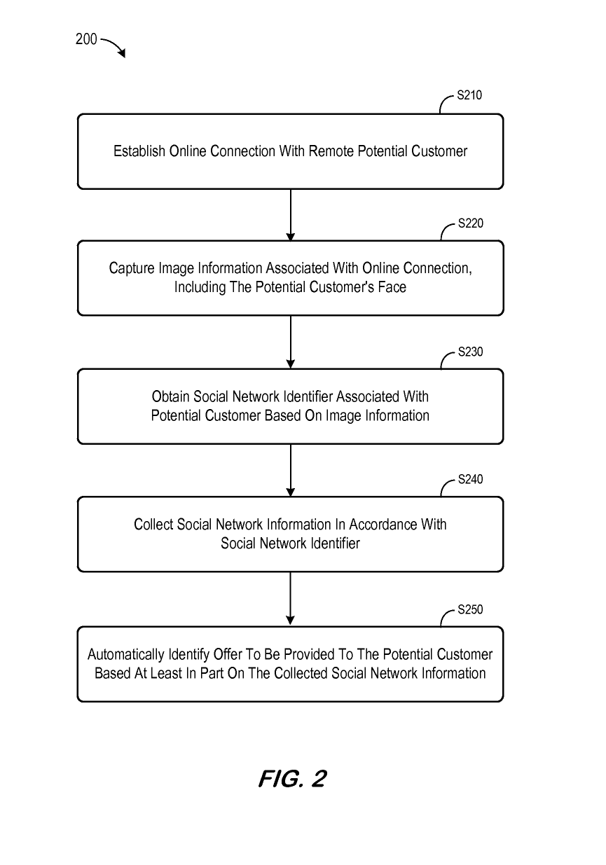

FIG. 2 is a flow diagram of a process 200 that might be associated with the sales engine 110 of FIG. 1 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S210, an online connection may be established with a remote potential customer. The online connection might be established with, for example, PC, a mobile computer, a smart phone, a game system, a television, and/or a kiosk (e.g., located at a shopping mall). At S220, image information associated with the online connection is captured, the image information including the potential customer's face. For example, a web camera of the potential customer device might stream video information to a sales engine. Similarly, a potential customer might take his or her picture (that is, a non-moving image) using a wireless telephone.

A social network identifier associated with the potential customer may then be obtained at S230 based on the image information. For example, facial recognition software might be executed at a sales engine or another device to compare the received image information with millions of stored social network profile pictures. As used herein, the phrase “social network identifier” may refer to any data that might be used to associate a potential customer with a social network (e.g., his or her screen name or email address registered with the social network). Social network information may then be collected at S240 in accordance with the social network identifier. For example, the collected social network information might include an age, a gender, a relationship status (e.g., whether the potential customer is married or single), interest information (e.g., his or her hobbies or favorite web sites), friend information (e.g., how many friends he or she has or what activities are of interest to those friends), family information (e.g., how many children he or she has), a level on online activity (e.g., whether or not he or she post something everyday), and/or a geographic location (e.g., a ZIP code, hometown, or latitude and longitude information).

According to some embodiments, the collected social network information is associated with a plurality of social networks (e.g., both Facebook and twitter information might be collected). Note that the social network information is associated with any social network site or service, including Facebook, twitter, LinkedIn, foursquare, tumblr, YouTube, flickr, digg, last fm, upcoming, mybloglog, slideshare, MySpace, and/or a third party service associated with a plurality of social networks.

At S250, an offer to be provided to the potential customer may be “automatically” identified based at least in part on the collected social network information. As used herein, the term “automated” may refer to, for example, actions that can be performed with little or no human intervention. Note that the offer may be selected from a plurality of potential offers by a sales engine or by another device. The sales representative may then provide the offer to the potential customer (e.g., by asking if he or she is interested in purchasing a magazine subscription at a discounted price).

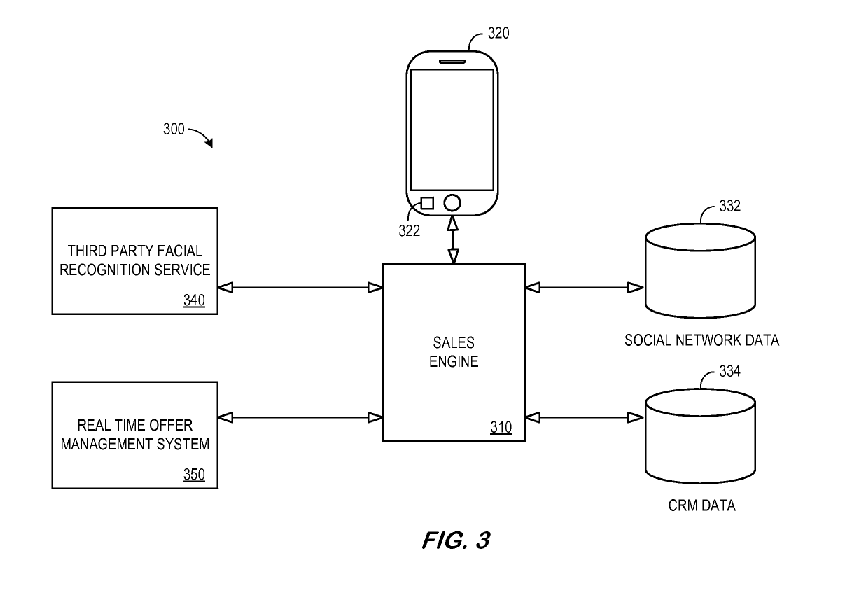

FIG. 3 is more detailed diagram of a system 300 in accordance with some embodiments. As before, the system 300 includes a sales engine 110 that may establish a connection with a potential customer via a remote customer device 120 (e.g., the potential customer's smart phone). Moreover, the remote customer device 120 includes a camera 322 adapted to capture an image (e.g., an image of the potential customer including his or her face).

According to some embodiments, the sales engine 310 is further able to access social network data 332 (e.g., unstructured and/or scattered data) and CRM data 334 (e.g., structured and/or formal data). The CRM data 334 may be associated with a CRM system or application that manages an enterprise's interactions with customers, clients and/or sales prospects. The CRM system may organize, automate, and/or synchronize business processes (e.g., sales activities, marketing, customer service, and/or technical support) to help find new customers and maintain existing customers

According to some embodiments, the sales engine 310 also communicates with a third party facial recognition service 340. The third party facial recognition service 340 might receive image information, analyze and compare the image information with social network profile pictures, and/or provide a social network address or identifier when a match is found. By way of example only, the third party facial recognition service 340 may be associated with face.com.

The sales engine 310 may also be communication with a real time offer management system 350. The real time offer management system 350 might, for example, receive data about a potential customer (e.g., the potential customer's age and gender), analyze a pool of potential offers using the received data, and output one or more offers that may be appropriate based on the received data.

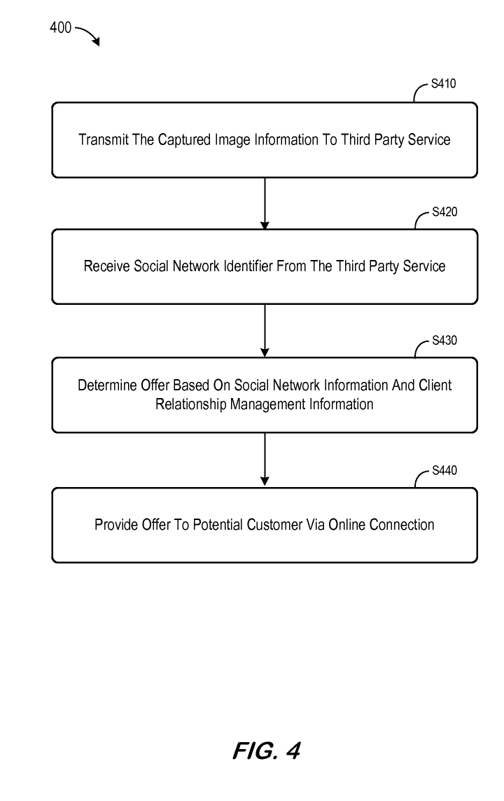

FIG. 4 is a flow diagram of a process that might be associated with the sales engine 310 of FIG. 3 according to some embodiments disclosed herein. At S410, captured image information may be transmitted to a third party service. For example, image information generated by the camera 322, including the potential customer's face, might be transmitted from the sales engine 310 to the third party facial recognition service 340 in accordance with the Joint Photographic Group (“JPG”) protocol. At S420, a social network identifier may be received from the third party service.

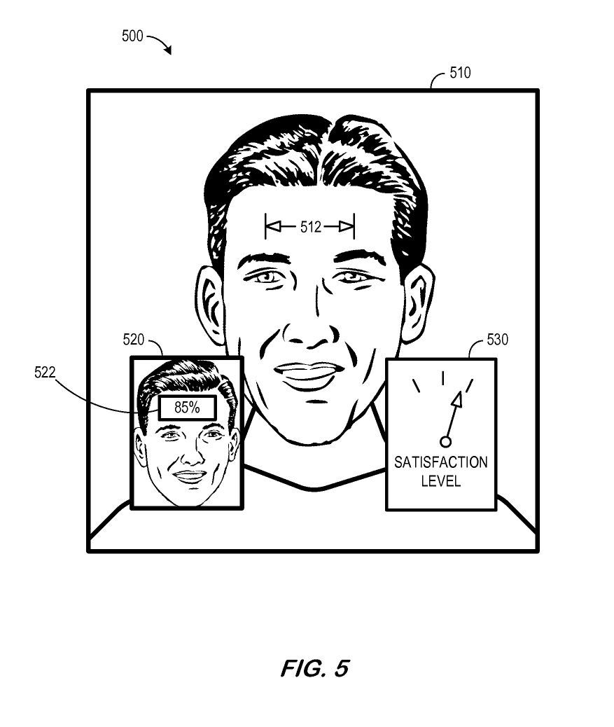

Consider, for example, FIG. 5 which illustrates a facial recognition display 500 in accordance with some embodiments. The captured image 510 of the potential customer's face might be analyzed by the third party facial recognition service 340. For example, a distance between the eyes 512 or other facial features might be calculated and compared to those of social network profile pictures until a matching profile picture 520 is found. According to some embodiments, a level of confidence value 522 is received from the third party facial recognition service 340 along with the social network identifier (e.g., indicating that there is an 85% likelihood that the matching profile picture 520 is in fact that of the potential customer). According to some embodiments, the captured image 510 is further analyzed to determine a satisfaction level or other emotional response (e.g., indicating how happy or angry the potential customer is). By way of example only, the sales engine 310 might detect a number of smiles or yawns, an amount of eye contact, and/or analyze audio information to determine an emotional response associated with the potential customer. According to some embodiments, the emotional response information may be used to select or modify an offer.

The sales engine 310 may then use the social network identifier received from the third party service to access the social network data 332. Similarly, the sales engine 310 may use the social network identifier and/or the social network data 332 to access to access the CRM data 334. The CRM data 334 may include any information associated with the potential customer, including a table of an Enterprise Resource Planning (“ERP”) system, a relational database such as SAP MaxDB, Oracle, Microsoft SQL Server, IBM DB2, Teradata and the like. As another example, the CRM data 334 might be associated with a multi-dimensional database, an eXtendable Markup Language (“XML”) document, or any other structured data storage system. The physical tables of a database may be distributed among several relational databases, dimensional databases, and/or other data sources.

Referring again to FIG. 4, at S430 an offer may be determined based on the social network data 332 and CRM data 334. For example, the sales engine 310 might transmit the social network data 332 and CRM data 334 to the real time offer management system 350 and receive back information about the offer. According to some embodiments, the real time offer management system 350 selects the offer from a plurality of potential offers in accordance with a weighted analysis of the social network and/or CRM data. Moreover, information about a plurality of offers might be received from the real time offer management system 350.

At S440, the offer may be provided to the potential customer via the online connection. For example, the sales representative might verbally extend the offer to the potential customer and/or transmit an electronic indication, contract, and/or coupon associated with the offer to the remote customer device 320. The sales representative and/or sales engine 310 might then receive from the potential customer an indication of acceptance of the offer (or non-acceptance).

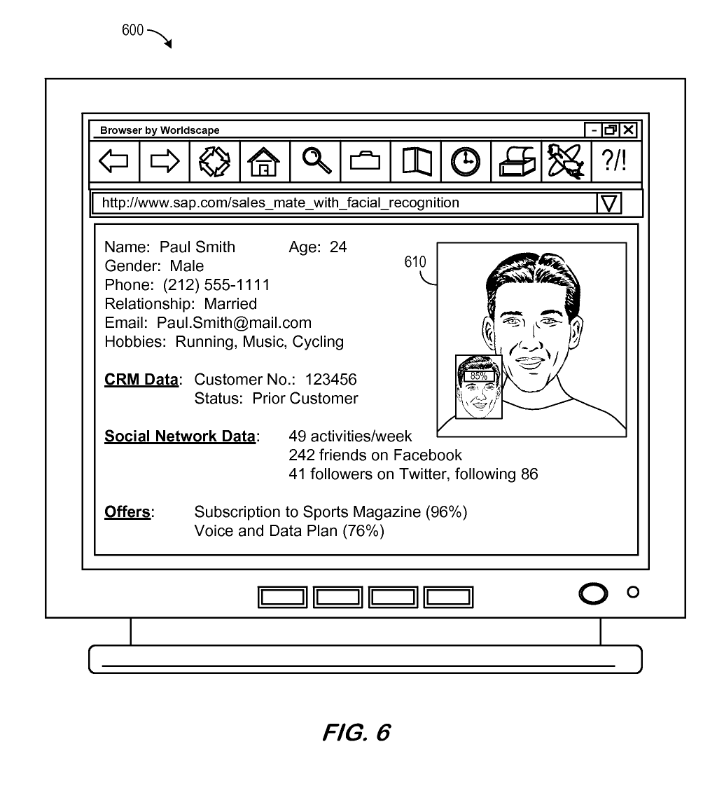

FIG. 6 illustrates a display 600 that might be provided to a sales representative according to some embodiments. The display 600 includes a facial recognition portion 610 that might include, for example, the potential customer's current video feed, probably social network profile picture (along with an indication of likelihood that the profile picture is in fact the potential customer), and/or emotional response information. The display 600 further includes social network information (e.g., how often the potential customer posts information to a social network) and CRM information (e.g., prior purchases and/or his or her current status as a customer). Finally, the display 600 includes one or more offers that have been selected for the customer based at least in part on the social network information. According to some embodiments, an indication of an offer's likely attractiveness to the potential customer is also provided on the display (e.g., a particular offer may represent 96% of an ideal offer for that customer).

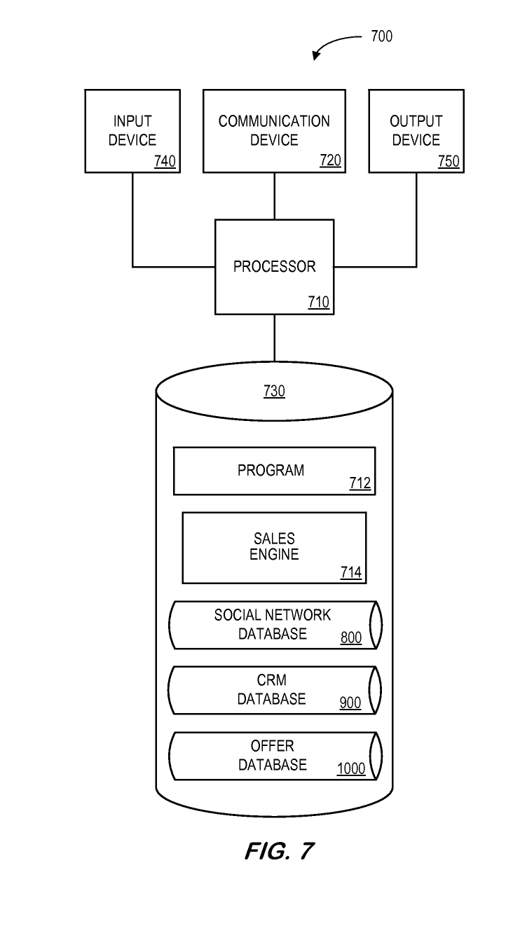

FIG. 7 is a block diagram overview of a sales engine 700 according to some embodiments. The sales engine 700 may be, for example, associated with any of the devices described herein. The sales engine 700 comprises a processor 710, such as one or more commercially available Central Processing Units (CPUs) in the form of one-chip microprocessors, coupled to a communication device 720 configured to communicate via a communication network (not shown in FIG. 7). The communication device 720 may be used to communicate, for example, with one or more remote customer devices, social network sites, CRM applications, facial recognition services, and/or offer management systems. The sales engine 700 further includes an input device 740 (e.g., a mouse and/or keyboard to enter information about potential customers, offers, and/or acceptances of offers) and an output device 750 (e.g., a computer monitor to display information about potential customers and/or offers).

The processor 710 communicates with a storage device 730. The storage device 730 may comprise any appropriate information storage device, including combinations of magnetic storage devices (e.g., a hard disk drive), optical storage devices, and/or semiconductor memory devices. The storage device 730 stores a program 712 and/or sales engine application 714 for controlling the processor 710. The processor 710 performs instructions of the programs 712, 714, and thereby operates in accordance with any of the embodiments described herein. For example, the processor 710 may establish an online connection with a remote potential customer via the communication device 720. Image information, including the potential customer's face, may be captured and used to obtain a social network identifier associated with the potential customer. Social network information may then be collected by the processor 710, and an offer to be provided to the potential customer may be automatically identified based at least in part on the collected social network information. According to some embodiments, customer relationship management information may also be used to identify to offer.

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the sales engine 700 from another device; or (ii) a software application or module within the sales engine 700 from another software application, module, or any other source.

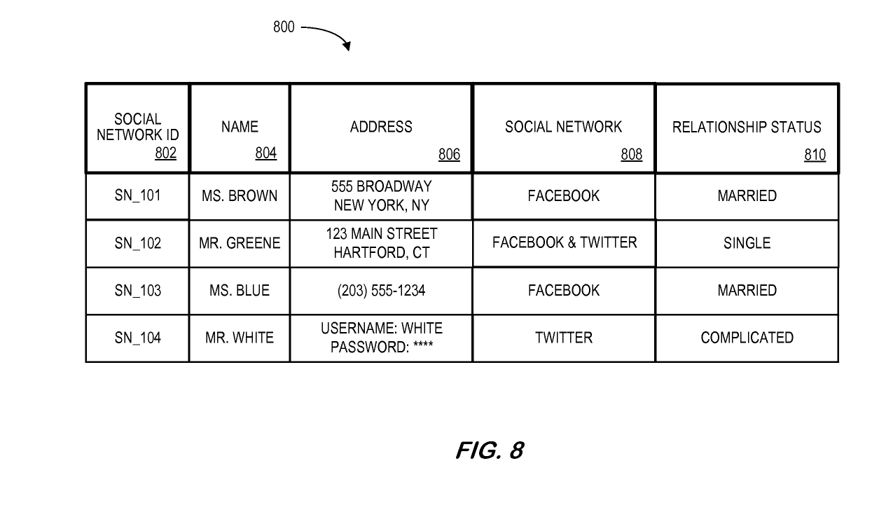

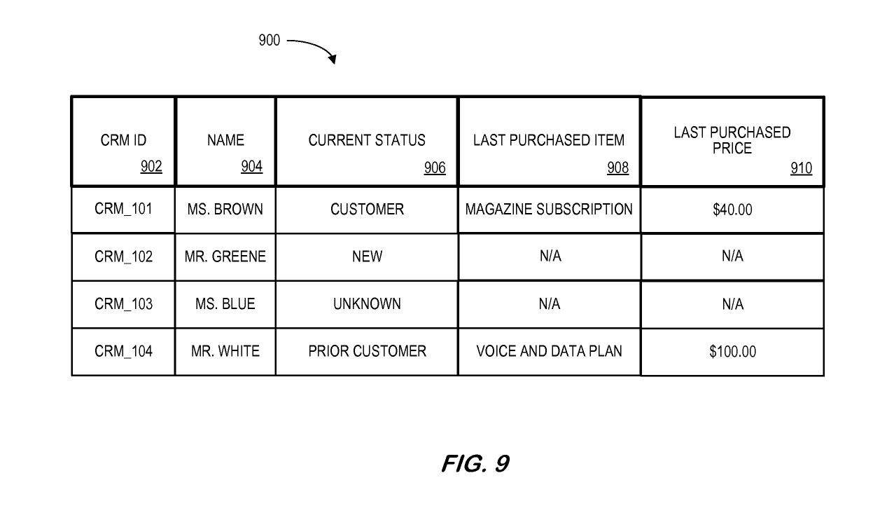

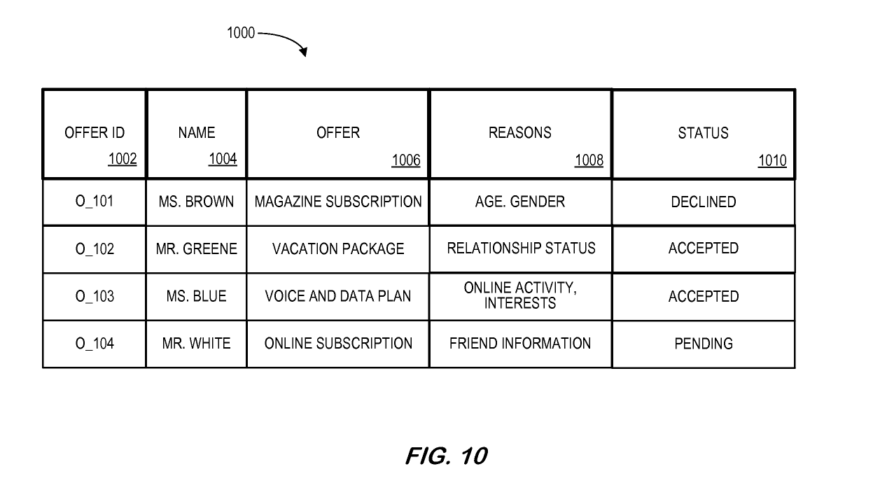

In some embodiments (such as shown in FIG. 7), the storage device 730 stores an social network database 800 (described with respect to FIG. 8), a CRM database 900 (described with respect to FIG. 9), and an offer database 1000 (described with respect to FIG. 10). Examples of databases that may be used in connection with the sales engine 700 will now be described in detail with respect to FIGS. 8 through 10. Note that the databases described herein are examples, and additional and/or different information may be stored therein. Moreover, various databases might be split or combined in accordance with any of the embodiments described herein.

Referring to FIG. 8, a table is shown that represents the social network database 800 that may be stored at the sales engine 700 according to some embodiments. The table may include, for example, entries identifying social network data associated with potential customers. The table may also define fields 802, 804, 806, 808, 810 for each of the entries. The fields 802, 804, 806, 808, 810 may, according to some embodiments, specify: a social network identifier 802, a name 804, an address 806, a social network 808, and relationship 810. The information in the social network database 800 may be created and updated, for example, based on data received from a social network server.

The social network identifier 802 may be, for example, a unique alphanumeric code identifying the social network data being collected for a potential customer. The name 804 might represent the potential customer's name and the address 806 might represent his or her postal address, phone number, email address, account username and password, or any other information that might be used to communicate with the potential customer. The social network 808 might indicate which social networks in which he or she participates. The relationship status 810 might indicate, for example, whether the potential customer is married. Note that other information may be stored in the social network database 800 in addition to that illustrated in FIG. 8. For example, an age, a gender, interest information, friend information, family information, and/or a level on online activity might also be stored in the social network database 800.

Referring to FIG. 9, a table is shown that represents the CRM database 900 that may be stored at the sales engine 700 according to some embodiments. The table may include, for example, entries identifying CRM data associated with potential customers. The table may also define fields 902, 904, 906, 908, 910 for each of the entries. The fields 902, 904, 906, 908, 910 may, according to some embodiments, specify: a CRM identifier 902, a name 904, a current status 906, and a last purchased item 908, and a last purchased price 910. The information in the CRM database 900 may be created and updated, for example, based on data received from a CRM system or application.

The CRM identifier 902 may be, for example, a unique alphanumeric code identifying the CRM data being collected for a potential customer. The name 904 might represent the potential customer's name (and may or may not be based on or identical to the name 802 stored in the social network database 800) while the current status 906 might represent whether he or she is currently a customer (or perhaps he or she was a customer in the past). The last purchased item 908 might indicate the type of product that was previously purchased by the potential customer, and the last purchased price 910 might indicate the value of the item. Note that other information may be stored in the CRM database 900 in addition to that illustrated in FIG. 9. For example, transaction identifiers, detailed purchased histories, and/or previously accepted or rejected offers could also be stored in the CRM database 900.

Referring to FIG. 10, a table is shown that represents the offer database 1000 that may be stored at the sales engine 700 according to some embodiments. The table may include, for example, entries identifying offer data associated with potential customers. The table may also define fields 1002, 1004, 1006, 1008, 1010 for each of the entries. The fields 1002, 1004, 1006, 1008, 1010 may, according to some embodiments, specify: an offer identifier 1002, a name 1004, an offer 1006, reasons 1008, and a status 1010. The information in the offer database 1000 may be created and updated, for example, based on data received from a real time offer management system and/or from a potential customer.

The offer identifier 1002 may be, for example, a unique alphanumeric code identifying an offer that has been (or may be) provided to a potential customer. The name 1004 might represent the potential customer's name (and may or may not be based on or identical to the name 802 stored in the social network database 800 and/or the name 902 stored in the CRM database 900) while the offer 1006 might describe the type of offer and/or the terms of the offer in detail. The reasons 1008 may indicate that that particular offer was selected for the potential customer, and the status may represent whether the offer was accepted, declined, or perhaps still pending in connection the potential customer. Note that other information may be stored in the offer database 1000 in addition to that illustrated in FIG. 10. For example, an offering party, an offer strength, and/or an offer expiration date could also be stored in the offer database 1000.

Thus, some embodiments may provide a method and mechanism to efficiently, accurately, and automatically select appropriate offers for a potential customer. Comprehensive profiling may let a sales representative know the customer and provide a personalized experience.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to particular types of offers, note that embodiments may be associated with other types of offers. For example, banking, financial institution, and/or health services related offers may be processed in accordance with any of the embodiments described herein.

In addition, some embodiments have been described herein with respect to an online connection (e.g., between a sales representative and a potential customer). Note, however, that embodiments might be associated with other types of customer interactions. For example, a sales representative might meet a customer in person (“face-to-face”) and use an image capturing device (e.g., a camera embedded in a smart phone) to obtain image information, including the customer's face. This image information could then be used to determine a social network identifier and/or identify appropriate offers to be provided to the potential customer.

Moreover, while embodiments have been illustrated using particular ways of providing offers, embodiments may be implemented in any other of a number of different ways. For example, some embodiments might be associated with an electronic delivery of an offer as opposed to an offer verbally provided by a sales representative.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer implemented method, comprising:
obtaining a social network identifier associated with a potential customer based on image information that includes the potential customer's face;
collecting social network information in accordance with the social network identifier; and
automatically identifying an offer to be provided to the potential customer based at least in part on the collected social network information.

2. The method of claim 1, wherein the potential customer comprises a remote potential customer and further comprising, prior to said obtaining:
establishing an online connection with the remote potential customer; and
capturing the image information via the online connection.

3. The method of claim 1, further comprising:
responsive to obtaining the social network identifier, collecting customer relationship management information associated with the potential customer, wherein the offer is further identifier based at least in part on the collected customer relationship management information.

4. The method of claim 1, wherein said obtaining comprises:
transmitting the captured image information to a third party service; and
receiving the social network identifier from the third party service.

5. The method of claim 4, wherein the image information comprises at least one of: (i) a non-moving image, or (ii) video information.

6. The method of claim 4, wherein a level of confidence value is received along with the social network identifier.

7. The method of claim 1, wherein the online connection is established with a customer device comprising at least one of: (i) a personal computer, (ii) a mobile computer, (iii) a smart phone, (iv) a game system, (v) a television, or (vi) a kiosk.

8. The method of claim 1, wherein the social network information includes at least one of: (i) an age, (ii) a gender, (iii) a relationship status, (iv) interest information, (v) friend information, (vi) family information, (vii) a level on online activity, or (viii) a geographic location.

9. The method of claim 1, further comprising;
obtaining emotional response information based on the captured image information, wherein the offer is further identified based at least in part on the emotional response information.

10. The method of claim 1, wherein automatically identifying the offer comprises:
transmitting the social network information to a real time offer management system; and
receiving information about the offer from the real time offer management system.

11. The method of claim 10, wherein the real time offer management system selects the offer from a plurality of potential offers in accordance with a weighted analysis of the social network information.

12. The method of claim 11, wherein information about a plurality of offers are received from the real time offer management system.

13. The method of claim 1, further comprising:
providing the offer to the potential customer via the online connection; and
receiving from the potential customer an indication of acceptance of the offer.

14. The method of claim 1, wherein the collected social network information is associated with a plurality of social networks.

15. The method of claim 1, wherein the social network information is associated with at least one of: (i) Facebook, (ii) twitter, (iii) LinkedIn, (iv) foursquare, (v) tumblr, (vi) YouTube, (vii) flickr, (viii) digg, (ix) last fm, (x) upcoming, (xi) mybloglog, (xii) slideshare, (xiii) MySpace, or (xiv) a third party service associated with a plurality of social networks.

16. A non-transitory, computer-readable medium storing program code executable by a computer to:
capture image information associated with a potential customer, the image information including the potential customer's face;
obtain a social network identifier associated with the potential customer based on the image information;
collect social network information in accordance with the social network identifier; and
automatically identify an offer to be provided to the potential customer based at least in part on the collected social network information.

17. The medium of claim 16, further storing program code executable by the computer to:
responsive to obtaining the social network identifier, collect customer relationship management information associated with the potential customer, wherein the offer is further identifier based at least in part on the collected customer relationship management information.

18. The medium of claim 16, wherein the image information comprises at least one of: (i) a non-moving image, or (ii) video information.

19. The medium of claim 16, wherein an online connection is established with a customer device comprising at least one of: (i) a personal computer, (ii) a mobile computer, (iii) a smart phone, (iv) a game system, (v) a television, or (vi) a kiosk.

20. The medium of claim 16, wherein the social network information includes at least one of: (i) an age, (ii) a gender, (iii) a relationship status, (iv) interest information, (v) friend information, (vi) family information, (vii) a level on online activity, or (viii) a geographic location.

21. A system, comprising:
a communication device to establish an online connection with a remote potential customer; and
a sales engine coupled to the communication device, to:
capture image information associated with the online connection, the image information including the potential customer's face,
obtain a social network identifier associated with the potential customer based on the image information,
collect social network information in accordance with the social network identifier, and
automatically identify an offer to be provided to the potential customer based at least in part on the collected social network information.

22. The system of claim 21, wherein the sales engine is further to:
responsive to obtaining the social network identifier, collect customer relationship management information associated with the potential customer, wherein the offer is further identifier based at least in part on the collected customer relationship management information.
